(19) United States
(12) Patent Application Publication
(10) Pub. No.: US 2014/0071712 A1
(43) Pub. Date: Mar. 13, 2014

(54) BACKLIGHT MODULE AND DISPLAY PANEL

(71) Applicant: Yanxue Zhang, Guangdong (CN)

(72) Inventor: Yanxue Zhang, Guangdong (CN)

(73) Assignee: SHENZHEN CHINA STAR OPTOELECTRONICS TECHNOLOGY CO., LTD., Guangdong (CN)

(21) Appl. No.: 13/702,289

(22) PCT Filed: Sep. 17, 2012
(86) PCT No.: PCT/CN2012/081464

§ 371 Date: Dec. 5, 2012

(30) Foreign Application Priority Data
Sep. 12, 2012 (CN) 201210335607.6

(51) Int. Cl. F21V 8/00

(52) U.S. Cl. CPC G02B 6/0035
USPC 362/624

(57) ABSTRACT

The present invention provides a backlight module and a display panel. The backlight module includes a back plate, a light guide plate and a light source. The back plate disposes a reflection layer on an inner surface thereof. The reflection layer and the back plate are integrally formed. A light enters into the light guide plate from a light incident surface of the light guide plate to be projected toward the inner surface of the back plate, then returns to the light guide plate after being reflected by the reflection layer on the inner surface of the light guide plate, and is emitted from a light emitting surface of the light guide plate. The present invention can not be effected by the external influence to cause deformation and other problems, thereby improving the reflection effect.

### BACKGROUND OF THE INVENTION

1. Field of the Invention

The present invention relates to a display panel manufacturing technology field, and more particularly to a backlight module and a display panel.

2. Description of the Prior Art

With the continuous popular of a display panel, the demand for the function of every component of the display panel becomes more and more high.

For a backlight module, a reflection type of the prior backlight module is generally employing a reflection sheet to dispose on the inner surface of a back plate. For example, please refer to FIG. 1, FIG. 1 is an exploded structure schematic view of the back plate 12 and the reflection sheet 11 in the prior art.

The reflection sheet 11 is mounted on the inner surface of the back plate 12 for reflecting the light being projected to the inner surface of the back plate 12. The back plate 12 also forms a number of protrusions 121 by a stamping way. The backlight module employs the protrusions 121 of the back plate 12 to realize the assembly with an overall unit.

However, the above way has the following disadvantages: because the reflection sheet 12 is separately manufactured and then mounted on the inner surface of the back plate 12, once the refection sheet 12 is subject to an external impact (such as stress, heat, temperature and humidity) to cause deformation, it will directly affect the light reflection effect of the refection sheet 12 and further result in the display effect of a display device being bad.

Hence, it needs to solve the above technical problem existing in the prior art.

### BRIEF SUMMARY OF THE INVENTION

One object of the present invention is to provide a backlight module to solve the technical problem of a refection sheet being subject to an external impact to cause deformation, further affect the light reflection effect, and result in the bad display effect of a display device in the prior art.

For solving above problems, the present invention provides a backlight module, comprising a back plate, a light guide plate and a light source. The light guide plate includes a light incident surface, a bottom surface and a light emitting surface. An inner surface of the back plate is planar and is connected to the bottom surface of the light guide plate. The light source is disposed at the light incident surface of the light guide plate. Wherein,

The back plate disposes a reflection layer on the inner surface thereof. The reflection layer and the back plate are integrally formed. A light enters into the light guide plate from the light incident surface of the light guide plate to be projected toward the inner surface of the back plate, then returns to the light guide plate after being reflected by the reflection layer on the inner surface of the light guide plate, and is emitted from the light emitting surface of the light guide plate.

The back plate disposes a number of fixing members on an outer surface thereof. The fixing members protrude with respect to the outer surface of the back plate.

In one embodiment of the present invention, the reflection layer is formed by coating the inner surface of the back plate with a reflective material.

In one embodiment of the present invention, the reflective material is a white reflective material.

In one embodiment of the present invention, the fixing members are rivets, and the rivets are fixedly connected with the outer surface of the back plate by a riveting way.

Another object of the present invention is to provide a backlight module to solve the technical problem of a refection sheet being subject to an external impact to generate a deformation, further affect the light reflection effect, and result in the bad display effect of a display device in the prior art.

For solving above problems, the present invention provides a backlight module, comprising a back plate, a light guide plate and a light source. The light guide plate includes a light incident surface, a bottom surface and a light emitting surface. An inner surface of the back plate is connected to the bottom surface of the light guide plate. The light source is disposed at the light incident surface of the light guide plate. Wherein,

The back plate disposes a reflection layer on the inner surface thereof. The reflection layer and the back plate are integrally formed. A light enters into the light guide plate from the light incident surface of the light guide plate to be projected toward the inner surface of the back plate, then returns to the light guide plate after being reflected by the reflection layer on the inner surface of the light guide plate, and is emitted from the light emitting surface of the light guide plate.

In one embodiment of the present invention, the reflection layer is formed by coating the inner surface of the back plate with a reflective material.

In one embodiment of the present invention, the reflective material is a white reflective material.

In one embodiment of the present invention, the back plate further has an outer surface, the outer surface disposes a number of fixing members thereon, and the fixing members protrude with respect to the outer surface of the back plate.

In one embodiment of the present invention, the fixing members are rivets, and the rivets are fixedly connected with the outer surface of the back plate by a riveting way.

Another object of the present invention is to provide a display panel to solve the technical problem of a refection sheet being subject to an external impact to generate a deformation, further affect the light reflection effect, and result in the bad display effect of a display device in the prior art.

For solving above problems, the present invention provides a display panel comprising a backlight module. The backlight module comprises a back plate, a light guide plate and a light source. The light guide plate includes a light incident surface, a bottom surface and a light emitting surface. An inner surface of the back plate is connected to the bottom surface of the light guide plate. The light source is disposed at the light incident surface of the light guide plate. Wherein,

The back plate disposes a reflection layer on the inner surface thereof. The reflection layer and the back plate are integrally formed. A light enters into the light guide plate from the light incident surface of the light guide plate to be projected toward the inner surface of the back plate, then returns to the light guide plate after being reflected by the reflection layer on the inner surface of the light guide plate, and is emitted from the light emitting surface of the light guide plate.

In one embodiment of the present invention, the reflection layer is formed by coating the inner surface of the back plate with a reflective material.

In one embodiment of the present invention, the reflective material is a white reflective material.

In one embodiment of the present invention, the back plate further has an outer surface, the outer surface disposes a number of fixing members thereon, and the fixing members protrude with respect to the outer surface of the back plate.

In one embodiment of the present invention, the fixing members are rivets, and the rivets are fixedly connected with the outer surface of the back plate by a riveting way.

Comparing with the prior art, the present invention designs the inner surface of the back plate to be planar, and coats the reflective material to form the reflection layer. The light entering into the light guide plate from the light incident surface of the light guide plate is projected toward the inner surface of the back plate, then is reflected by the reflection layer on the inner surface of the back plate, returns to the light guide plate, and is emitted from the light emitting surface of the light guide plate. Obviously, the present invention may solve the technical problem of a refection sheet being subject to an external impact to cause deformation, further affect the light reflection effect, and result in the bad display effect of a display device in the prior art, thereby assuring the display effect of the display device.

For more clearly and easily understanding above content of the present invention, the following text will take a preferred embodiment of the present invention with reference to the accompanying drawings for detail description as follows.

### BRIEF DESCRIPTION OF THE DRAWINGS

FIG. 1 is a schematic view of a partial structure of a backlight module in the prior art;

FIG. 2 is an exploded structure schematic view of a preferred embodiment of a backlight module of the present invention;

FIG. 3 is a schematic view of an inner surface of a back plate in the present invention; and

FIG. 4 is a schematic view of an outer surface of the back plate in the present invention.

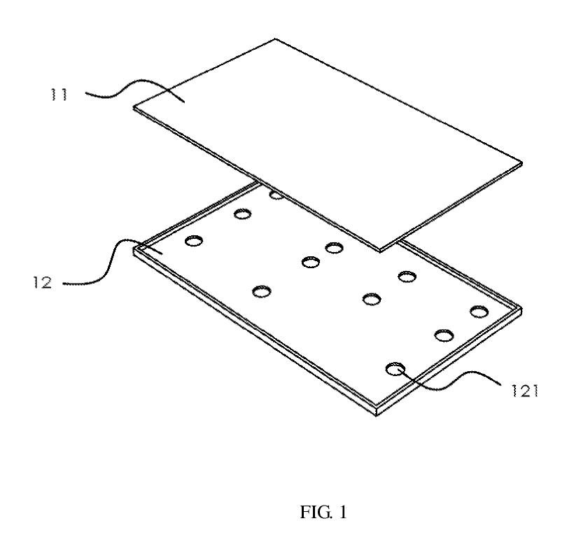

### DETAILED DESCRIPTION OF THE PREFERRED EMBODIMENTS

The following description of every embodiment with reference to the accompanying drawings is used to exemplify a specific embodiment, which may be carried out in the present invention. Directional terms mentioned in the present invention, such as “top”, “bottom”, “front”, “back”, “left”, “right”, “inner”, “outer”, “side” etc., are only used with reference to the orientation of the accompanying drawings. Therefore, the used directional terms are intended to illustrate, but not to limit, the present invention. In the drawings, the components having similar structures are denoted by the same numerals.

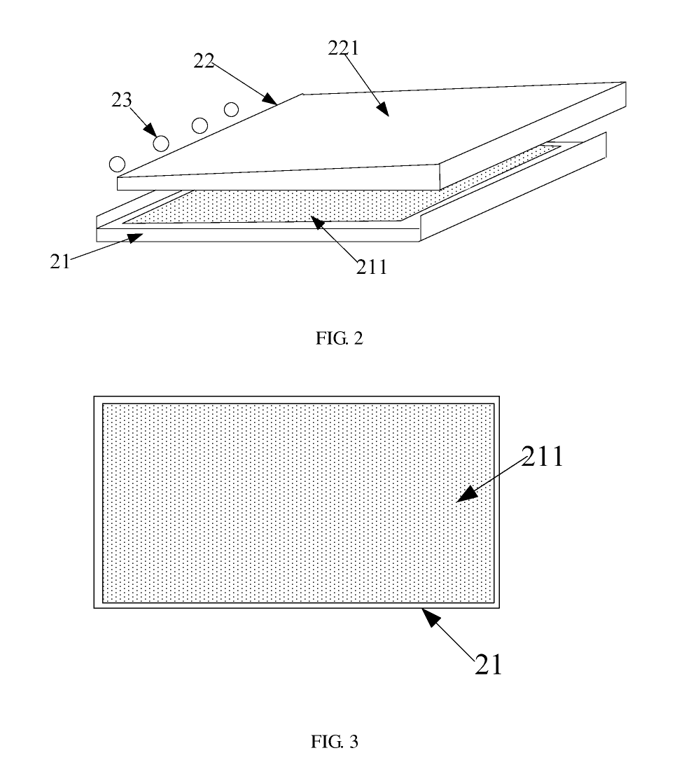

Please refer to FIG. 2, FIG. 2 is an exploded structure schematic view of a preferred embodiment of a backlight module of the present invention. The backlight module comprises a back plate 21, a light guide plate 22 and a light source 23.

The light guide plate 22 includes a light incident surface, a bottom surface (not labeled in the drawings) and a light emitting surface 221. The light source 23 is located at the light incident surface of the light guide plate 22, and the bottom surface of the light guide plate 22 is connected with the back plate 21.

The back plate 21 is a metal plate. The back plate 21 includes an inner surface and an outer surface (not labeled in the drawings). The inner surface of the back plate 21 is planar and is connected with the bottom surface of the light guide plate 22.

Please refer to FIG. 3, the inner surface of the back plate 21 disposes a reflection layer 211, and the reflection layer 211 and the back plate 21 are integrally formed. Preferably, the reflection layer 211 is formed by coating the inner surface of the back plate 21 with a reflective material. The reflective material preferably adopts a white reflective material. For example, the white reflective material is a paint containing a titanium dioxide powder and a barium sulfate powder. Of course, it also may be other reflective materials, as long as it can be coated on the inner surface of the back plate 21 to form the refection layer 211, and can reflect the light projected onto the inner surface of the back plate 21. So here is not listed one by one. It is notable that the “integrally formed” does not refer that the back plate 21 and the reflection layer 211 are made of a same material, but refer that the refection layer 211 is directly pre-formed on the inner surface of the back plate 21.

In the present invention, the refection layer 211 is formed on the inner surface of the back plate 21 by a coating way, such as a spray coating. Certainly, it also may be formed by other ways. No listed one by one herein.

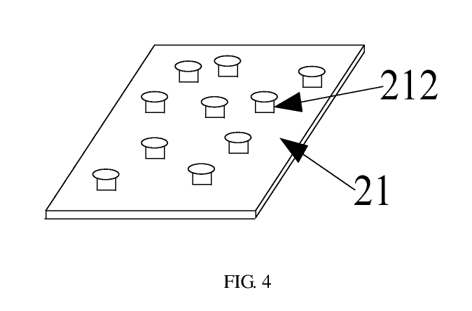

Please refer to FIG. 4, the outer surface of the back plate 21 is back to the inner surface. The outer surface of the back plate 21 disposes a number of fixing members 212. The fixing members 212 are protruding outward with respect to the outer surface of the back plate 21 (namely protruding away from the inner surface). The fixing members 212 may be integrally formed with the back plate 21 and protrude from the outer surface of the back plate 21, and also may be fixedly connected with the outer surface of the back plate 21 by other ways.

More preferably, the fixing members 212 are rivets. The rivets are fixedly connected with the outer surface of the back plate 21 by a riveting way. Of course, they also may be other fixing members, as long as they can protrude with respective to the outer surface of the back plate 21, and can realize the assembly of the backlight module and an overall unit. So here is no listed one by one.

The present invention disposes the fixing members 212 on the outer surface of the back plate 21, and assembles the back plate 21 to the overall unit by the fixing members 212. Comparing with the technology of protrusions formed by the stamping way, the fixing members of the present invention may save expense to reduce the manufacture cost of a display panel.

A working principle of the back plate provided by the present invention is described as follows:

Please refer to FIG. 2, the light emitted by the light source 23 enters into the light guide plate 22 from the light incident surface of the light guide plate 22. The light entering into the light guide plate 22 is projected onto the bottom surface of the light guide plate 22. The light projected onto the bottom surface of the light guide plate 22 is further projected onto the inner surface of the inner surface of the back plate 21. The light incident surface of the light guide plate 22 generally refers to a side wall of the light guide plate 22, and the light source 23 is located outside of the side wall of the light guide plate 22. But the light incident surface also may be the bottom surface of the light guide plate 22, and the light source 23 is located between the bottom surface of the light guide plate 22 and the back plate 21.

Because the inner surface of the back plate 21 forms the reflection layer 211, the light projected onto the inner surface of the back plate 21 can return to the light guide plate 22 after being reflected by the reflection layer 21, and finally can be emitted from the light emitting surface 221.

Obviously, the present invention disposes the reflection layer 211 on the inner surface of the back plate 21. The reflection layer 211 and the back plate 21 are integrally formed. For example, the reflection layer 211 is formed by coating the inner surface of the back plate 21 with the white reflective material. By this way, it can realize the object of the organic combination of the optical reflection structure and the back plate 21. Because the reflection layer 211 and the back plate 21 are integrally formed, it will not cause deformation and other problems, thereby assuring the reflection effect and further improving the optical effect of the backlight module. Comparing with the prior art, the present invention does not need the reflection sheet to greatly save the cost. Moreover, the fixing members 212 disposed on the outer surface of the back plate 21 may improve the assembly efficiency of the backlight module, and further save the cost.

The present invention further provides a display panel. The display panel comprises the backlight module provided by the present invention. The backlight module comprises the back plate 21, the light guide plate 22 and the light source 23. The inner surface of the back plate 22 forms the reflection layer 211 used to reflecting the light, wherein the reflection layer 211 and the back plate 21 are integrally formed. For example, the reflection layer 211 is formed by coating the inner surface of the back plate 21 with the white reflective material. The reflection layer 211 is used to reflect the light projected onto the inner surface of the back plate 21. Because the backlight module has been detail described in above text, no repeated herein.

The present invention designs the inner surface of the back plate to be planar, and coats the reflective material to form the reflection layer. The light entering into the light guide plate from the light incident surface of the light guide plate is projected toward the inner surface of the back plate, then is reflected by the reflection layer on the inner surface of the back plate, returns to the light guide plate, and is emitted from the light emitting surface of the light guide plate. Obviously, the present invention may solve the technical problem of a refection sheet being subject to an external impact to cause deformation, further affect the light reflection effect, and result in the bad display effect of a display device in the prior art, thereby assuring the display effect of the display device.

In conclusion, although the present invention has been disclosed by above preferred embodiments, above preferred embodiments are not used to limit the present invention. One of ordinary skills in the art also can make all sorts of improvements and amendments within the principles of the present invention. Therefore, the protection scope of the present invention should be based on the scope defined by the appended claims.

What is claimed is:

1. A backlight module, comprising a back plate, a light guide plate and a light source, the light guide plate including a light incident surface, a bottom surface and a light emitting surface, an inner surface of the back plate being planar and being connected to the bottom surface of the light guide plate, the light source being disposed at the light incident surface of the light guide plate, wherein,
the back plate disposing a reflection layer on the inner surface thereof, the reflection layer and the back plate being integrally formed, a light entering into the light guide plate from the light incident surface of the light guide plate to be projected toward the inner surface of the back plate, then returning to the light guide plate after being reflected by the reflection layer on the inner surface of the light guide plate, and being emitted from the light emitting surface of the light guide plate;
the back plate disposing a number of fixing members on an outer surface thereof, the fixing members protruding with respect to the outer surface of the back plate.

2. The backlight module as claimed in claim 1, wherein the reflection layer is formed by coating the inner surface of the back plate with a reflective material.

3. The backlight module as claimed in claim 2, wherein the reflective material is a white reflective material.

4. The backlight module as claimed in claim 1, wherein the fixing members are rivets, and the rivets are fixedly connected with the outer surface of the back plate by a riveting way.

5. A backlight module, comprising a back plate, a light guide plate and a light source, the light guide plate including a light incident surface, a bottom surface and a light emitting surface, an inner surface of the back plate being connected to the bottom surface of the light guide plate, the light source being disposed at the light incident surface of the light guide plate, wherein,
the back plate disposing a reflection layer on the inner surface thereof, the reflection layer and the back plate being integrally formed, a light entering into the light guide plate from the light incident surface of the light guide plate to be projected toward the inner surface of the back plate, then returning to the light guide plate after being reflected by the reflection layer on the inner surface of the light guide plate, and being emitted from the light emitting surface of the light guide plate.

6. The backlight module as claimed in claim 5, wherein the reflection layer is formed by coating the inner surface of the back plate with a reflective material.

7. The backlight module as claimed in claim 6, wherein the reflective material is a white reflective material.

8. The backlight module as claimed in claim 5, wherein the back plate further has an outer surface, the outer surface disposes a number of fixing members thereon, and the fixing members protrude with respect to the outer surface of the back plate.

9. The backlight module as claimed in claim 8, wherein the fixing members are rivets, and the rivets are fixedly connected with the outer surface of the back plate by a riveting way.

10. A display panel, comprising a backlight module, which comprises a back plate, a light guide plate and a light source, the light guide plate including a light incident surface, a bottom surface and a light emitting surface, an inner surface of the back plate being connected to the bottom surface of the light guide plate, the light source being disposed at the light incident surface of the light guide plate, wherein,
the back plate disposing a reflection layer on the inner surface thereof, the reflection layer and the back plate being integrally formed, a light entering into the light guide plate from the light incident surface of the light guide plate to be projected toward the inner surface of the back plate, then returning to the light guide plate after being reflected by the reflection layer on the inner surface of the light guide plate, and being emitted from the light emitting surface of the light guide plate.

11. The display panel as claimed in claim 10, wherein the reflection layer is formed by coating the inner surface of the back plate with a reflective material.

12. The display panel as claimed in claim 11, wherein the reflective material is a white reflective material.

13. The display panel as claimed in claim 10, wherein the back plate further has an outer surface, the outer surface disposes a number of fixing members thereon, and the fixing members protrude with respect to the outer surface of the back plate.

14. The display panel as claimed in claim 13, wherein the fixing members are rivets, and the rivets are fixedly connected with the outer surface of the back plate by a riveting way.
